(19) United States
(12) Patent Application Publication
(10) Pub. No.: US 2015/0107711 A1
(43) Pub. Date: Apr. 23, 2015

(54) CYTOMETER FLOWCELL

(71) Applicant: CytoFlow, LLC, Durham, NC (US)

(72) Inventor: Nathaniel C. Bair, San Luis Obispo, CA (US)

(21) Appl. No.: 14/518,243

(22) Filed: Oct. 20, 2014

Related U.S. Application Data
(60) Provisional application No. 61/893,531, filed on Oct. 21, 2013.

(51) Int. Cl. G01N 15/14

(52) U.S. Cl. CPC G01N 15/1404; G01N 2015/1413
USPC 137/861

(57) ABSTRACT

A cytometer flowcell is configured to induce a substantial change of direction of a conducting fluid as it enters and exits a hydrodynamic focusing zone, where a sample fluid is combined with the conducting fluid. The flowcell includes a combined fluid conduit and a sample fluid injection probe. The combined fluid conduit defines a combined fluid inlet and an internal combined fluid flowpath, while a conducting fluid flowpath is defined outside of the combined fluid conduit. The sample fluid injection probe has an outlet that is spaced from the combined fluid inlet to form a hydrodynamic focusing zone. The combined fluid conduit, and the conducting fluid flowpath outboard of the combined fluid conduit, are arranged so that in operation, the conducting fluid will change direction by at least about 90 degrees as the conducting fluid enters the focusing zone and exits along the combined fluid flowpath.

### CROSS REFERENCE TO RELATED APPLICATION

The present application claims the benefit of U.S. provisional application Ser. No. 61/893,531, filed Oct. 21, 2013, which is hereby incorporated herein by reference in its entirety.

### FIELD OF THE INVENTION

The present invention relates generally to fluid-handling or fluidic systems in which it is desirable to precisely control two or more different fluids flowing simultaneously through a single fluid conduit with minimal turbulence, such as for fluid analysis or testing purposes.

### BACKGROUND OF THE INVENTION

Fluid-handling or fluidic systems in which two or more different and substantially unmixed fluids flow together through a conduit, such as for analysis or testing purposes, are designed to induce a constant-diameter flow of test fluid within a surrounding sheath fluid as the two fluids flow together through a flow channel or conduit. For example, a flow cytometer is a device used for optical detection of microscopic particles contained within a sample fluid that forms a “core”, which is surrounded by a conducting or “sheath” fluid, in which the two fluids flow simultaneously through a test chamber of a flowcell.

Typically, a sample fluid is injected through a sample injection probe and into the center of a stream of conducting fluid that is traveling in the same direction as the sample fluid. Known flow cytometers are described, for example, in U.S. Pat. Nos. 8,303,894; 8,283,177; 8,262,990; and 8,187,888, the disclosures of which are hereby incorporated herein by reference for purposes of general background information on known flow cytometer structures.

### SUMMARY OF THE INVENTION

The present invention provides a cytometer flowcell that directs two different and substantially unmixed fluids through a test chamber in the flowcell, in which a sample or “core” fluid remains substantially in the middle of the combined flow, and a conducting or “sheath” fluid substantially surrounds the sample fluid. The sample fluid and the conducting fluid are initially separate, and then meet at a hydrodynamic focusing zone, where the combined fluids enter a capillary or flow channel. The sample fluid enters the hydrodynamic focusing zone from a sample injection probe, with the sample fluid traveling in a substantially linear path. The diameter of the sample fluid flow narrows as it accelerates in the hydrodynamic focusing zone, and as it subsequently enters the flow channel. The conducting fluid enters the hydrodynamic focusing zone from a substantially different or opposite direction than the sample fluid. For example, the conducting fluid may enter the hydrodynamic focusing zone and turn approximately 180 degrees as it enters the flow channel with the sample fluid, whereby the conducting fluid reverses its flow direction as it enters and exits the hydrodynamic focusing zone. Optionally, the conducting fluid may perform a smaller direction change in the hydrodynamic focusing zone, such as by entering radially from the sides of the focusing zone and turning approximately 90 degrees as it enters the flow channel.

This flow direction reversal (or a significant change in flow direction) for the conducting fluid improves the stability of flow of both fluids through the flow channel, particularly in cases where the flow channel and the sample injection probe (or other fluid-handling components) may be somewhat misaligned. The arrangement also decreases the detrimental effects of bubbles and debris that may enter the focusing zone, such as by trapping them in turbulent eddies. Thus, a cytometer flowcell utilizing flow reversal or substantial direction change of the conducting fluid flowpath results in improved operation of the cytometer due to greater tolerance for misalignments and/or less susceptibility to contaminants that may enter the sample and conducting fluids.

According to one form of the present invention, a cytometer flowcell includes a combined fluid conduit and a sample fluid injection probe, with a conducting fluid outlet that is spaced downstream from the sample fluid injection probe. The combined fluid conduit defines an internal combined fluid flowpath that is downstream from a combined fluid inlet. A conducting fluid flowpath is defined outboard of the combined fluid conduit. The sample fluid injection probe has a sample fluid outlet that is spaced from the inlet of the combined fluid conduit, so that a hydrodynamic focusing zone is formed between the sample fluid outlet and the combined fluid inlet. The combined fluid conduit, and the conducting fluid flowpath that is located outboard of the combined fluid conduit, are arranged so that a flow of the conducting fluid will change direction by at least about 90 degrees as the conducting fluid enters the hydrodynamic focusing zone and exits along the combined fluid flowpath.

Optionally, the combined fluid conduit and the conducting fluid flowpath that is located outboard of the conduit, are arranged so that the conducting fluid will change direction by about 180 degrees as the conducting fluid enters the hydrodynamic focusing zone and exits the zone as it is drawn into the combined fluid inlet, and along the combined fluid flowpath.

In one aspect, the combined fluid conduit has an outer surface that defines an inner boundary of the conducting fluid flowpath, which is defined outboard of the combined fluid conduit. Optionally, the combined fluid conduit and the sample fluid injection probe are substantially parallel and/or coaxial to one another.

In another form of the present invention, a method is provided for directing fluids through a cytometer flowcell. The method includes the steps of (i) positioning a combined fluid conduit in the cytometer flowcell, the combined fluid conduit having a combined fluid inlet, and the combined fluid conduit defining an internal combined fluid flowpath in a downstream direction of the combined fluid inlet; (ii) positioning a sample fluid injection probe in the cytometer flowcell, the sample fluid injection probe having a sample fluid outlet; (iii) positioning the sample fluid outlet of the sample fluid injection probe in spaced arrangement from the combined fluid inlet to thereby form a hydrodynamic focusing zone between the sample fluid outlet and the combined fluid inlet; (iv) positioning a conducting fluid outlet outside of the combined fluid conduit and in the downstream direction of the combined fluid inlet; and (v) directing a flow of the conducting fluid out of the conducting fluid outlet, into the hydrodynamic focusing zone, and along the combined fluid flowpath, whereby the conducting fluid is caused to change direction by at least about 90 degrees.

Thus, the cytometer flowcell of the present invention provides a flow-reversing fluid path for a conducting/sheath fluid as it enters the hydrodynamic focusing zone and is combined with a sample/core fluid that enters the focusing zone substantially without changing direction. The sample/core fluid enters from a direction that is opposite or substantially different from the direction from which the conducting fluid enters the focusing zone. The arrangement allows the combined sample fluid core and conducting fluid sheath to flow substantially unmixed and without turbulence through the flow channel en route to a fluid analyzer located downstream. The arrangement also improves the performance of the cytometer by improving its ability to tolerate contaminants in the fluid and/or misalignments within the fluid system.

These and other objects, advantages, purposes and features of the present invention will become apparent upon review of the following specification in conjunction with the drawings.

### BRIEF DESCRIPTION OF THE DRAWINGS

FIG. 1 is a side elevation diagram of a prior art flowcell;

FIG. 2 is a side elevation diagram of a flowcell in accordance with the present invention;

FIG. 3 is a side elevation diagram of another flowcell in accordance with the present invention; and

FIG. 4 is a perspective view of a cytometer capable of incorporating the flowcell of either of FIGS. 2 and 3.

### DESCRIPTION OF THE PREFERRED EMBODIMENTS

The cytometer flowcell of the present invention provides a unique conducting fluid flowpath that follows a significant bend or turn through a hydrodynamic focusing zone, where it combines with a sample fluid and enters a combined fluid conduit or capillary flow channel. At the same time, the sample fluid follows a substantially straight flowpath through a sample injection probe and into the hydrodynamic focusing zone, where it is combined with the conducting fluid, and then into the combined fluid conduit. From the combined fluid conduit the fluids pass into a fluid analyzer of the cytometer. The conducting fluid may turn by approximately 90 degrees or more as it passes through the hydrodynamic focusing zone. This flowpath of the conducting fluid maintains stability of combined fluids through the combined fluid conduit, even in the presence of somewhat misaligned fluid conduits within the system, and also increases the system's ability to tolerate contaminants, such as air bubbles or foreign particles, which may collect in turbulent areas of the hydrodynamic focusing zone. This improves the overall operation and the ease of operation of a cytometer incorporating a flowcell in accordance with the present invention. It is envisioned that the cytometer flowcell would be compatible or adaptable for use with many different known flow cytometers, such as those described in U.S. Pat. Nos. 8,303,894; 8,283,177; 8,262,990; and 8,187,888, although it will be appreciated that the fluidic system of the present invention may be used in conjunction with other flow cytometers, and is in no way limited to those described in the above-referenced patents.

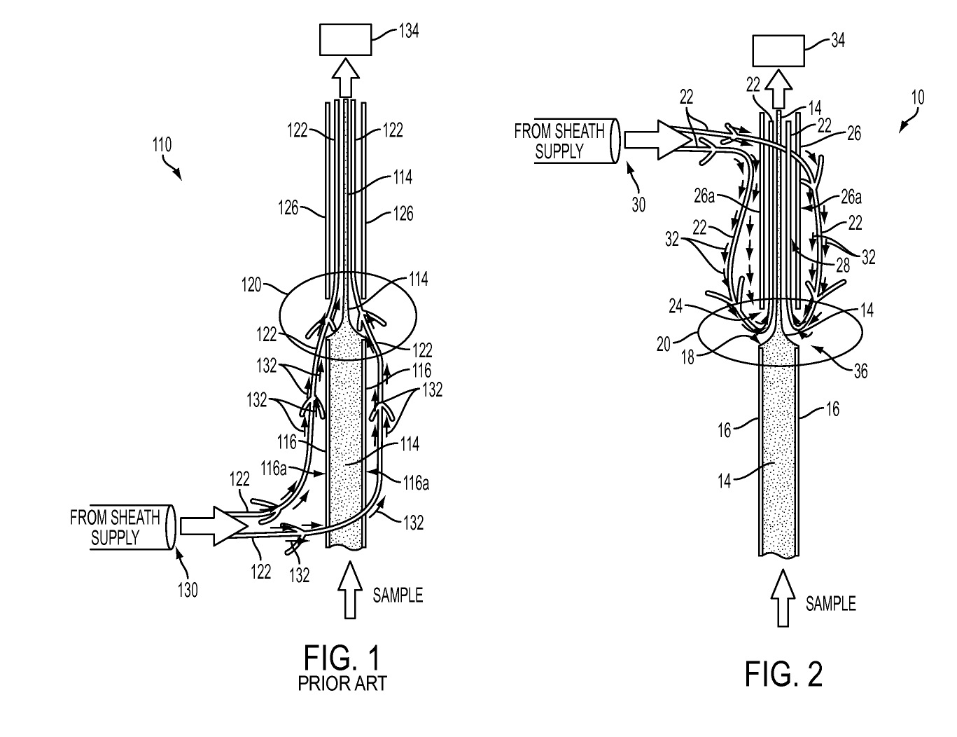

Referring now to the drawings and the illustrative embodiments depicted therein, a cytometer flowcell 10 (FIG. 2) moves fluids through a cytometer 12 (FIG. 4) in a precisely controlled manner, for the optical detection of microscopic particles contained within a sample fluid 14. Sample fluid 14 is directed through a sample injection probe 16, which has a sample fluid outlet 18 located in or near a hydrodynamic focusing zone 20, such as shown in FIG. 2. As sample fluid 14 passes through focusing zone 20, it is surrounded by a sheath of conducting fluid 22 that enters the focusing zone 20 from an opposite direction of sample injection probe 16. As will be described in more detail below, the flowpath of conducting fluid 22 includes a substantial change or reversal in direction in the vicinity of focusing zone 20, which provides several benefits to the operation of flowcell 10.

Sample fluid 14 and conducting fluid 22 enter the hydrodynamic focusing zone 20 from their respective sources, and are drawn (together, but substantially unmixed) into a combined fluid inlet 24 of a combined fluid conduit 26, such as shown in FIG. 2. The combined fluid conduit 26 may also be referred to as a “capillary channel” or “flow channel” in the field of cytometer flowcells. A combined fluid flowpath 28 is defined inside of combined fluid conduit 26, where the velocity of sample fluid 14 is greater than its velocity through sample injection probe 16. The resulting acceleration of sample fluid 14 in the area of focusing zone 20 results in a reduction of the diameter of the sample fluid 14 in the focusing zone 20. Thus, sample fluid 14 forms the central portion or “core” of the combined fluids 14, 22 as they are drawn along the combined fluid flowpath 28 inside of combined fluid conduit 26.

In the illustrated embodiment of FIG. 2, a conducting fluid outlet 30 is positioned in a location that is outboard of combined fluid conduit 26, and that is spaced in the downstream direction from hydrodynamic focusing zone 20. In this context, “downstream” refers to the direction of flow along the combined fluid flowpath 28 inside of combined fluid conduit 26, which is also the direction of flow of sample fluid 14 through sample injection probe 16. From conducting fluid outlet 30, conducting fluid 22 flows upstream relative to the flow direction inside of combined fluid conduit 26, along a conducting fluid flowpath 32 that is located outboard of combined fluid conduit 26, such that an outer peripheral surface 26a of combined fluid conduit 26 defines an inner boundary of the conducting fluid flowpath 32. Accordingly, as conducting fluid 22 is drawn from conducting fluid outlet 30, along conducting fluid flowpath 32, and into focusing zone 20 and then into combined fluid inlet 24, conducting fluid 22 follows flowpath 32 around a 180 degree bend, or a reversal of flow direction, as conducting fluid 22 enters combined fluid inlet 24 and forms a surrounding “sheath” around the sample fluid core 14, such as shown in FIG. 2. It is also envisioned that the conducting fluid flowpath could include a turn of greater than 180 degrees, or less than 180 degrees as described below.

This reversal or direction change of conducting fluid flowpath 32 causes at least some foreign matter that may be carried by conducting fluid 22 (such as air bubbles or particle contaminants) to be trapped in turbulent or stagnant areas of focusing zone 20, so that those potential contaminants will not be present in the conducting fluid as it passes through combined fluid conduit 26, and on to a fluid analyzer 34 that is located downstream. In addition, the reversal of flow direction of the conducting fluid 22 enhances the consistency and/or stability of the combined fluids 14, 22 as they flow together along combined fluid flowpath 28 and into the analyzer 34. Any instability of the fluids (e.g., turbulence) inside the analyzer 34 may adversely affect the analyzer's ability to properly analyze the sample fluid 14. Such turbulence is more likely to occur when sample injection probe 16 is offset from (or misaligned with) conducting fluid conduit 26. While it is most desirable that sample injection probe 16 is exactly parallel and coaxial with combined fluid conduit 26, it is recognized that misalignments do occur in practice. However, the formation of turbulence in the fluids, as a result of such misalignments, may be substantially reduced or eliminated by arranging a conducting fluid flowpath 32 as described above, in which conducting fluid 22 enters hydrodynamic focusing zone 20 from radial directions through a gap 36 that is defined between sample fluid outlet 18 and combined fluid inlet 24.

Although conducting fluid flowpath 32 is primarily shown and described herein as exhibiting a substantial reversal of flow direction, in which conducting fluid 22 changes flow direction by approximately 180 degrees, it will be appreciated that a lesser directional change may still provide the desired effect of reducing turbulence and reducing the likelihood that undesired bubbles or other contaminants will enter combined fluid conduit 26. For example, a conducting fluid outlet may be positioned substantially anywhere that is outboard along combined fluid conduit 26, or may be positioned radially outwardly from hydrodynamic focusing zone 20, and still provide a sufficient turn in the conducting fluid flowpath (such as about 90 degrees or more), within focusing zone 20, and while still providing the desirable effects that are described above.

By comparison, and with reference to FIG. 1, a traditional or prior art flowcell 110 utilizes a similar sample injection probe 116 for conveying sample fluid 114, and a similar combined fluid conduit 126 for conveying the combined sample fluid 114 and a conducting fluid 122. A hydrodynamic focusing zone 120 is defined in the region where sample fluid injection probe 116 and combined fluid conduit 126 are in close proximity to one another. In the prior art flowcell 110, however, a conducting fluid outlet 130 is positioned upstream of focusing zone 120, so that a conducting fluid flowpath 132 is along outer surfaces 116a of sample injection probe 116, with only a relatively shallow or mild shift in the flowpath 132 as conducting fluid 122 enters hydrodynamic focusing zone 120 and then combined fluid conduit 126. Such an arrangement is susceptible to the formation of turbulence, or the inclusion of air bubbles or other contaminants with conducting fluid 122 as it enters combined fluid conduit 126 and passes into a fluid analyzer 134, such as due to misalignments of sample injection probe 116 with combined fluid conduit 126. This arrangement is also more prone to conveying contaminants in the fluid(s) into the combined fluid conduit 126 and the fluid analyzer 134.

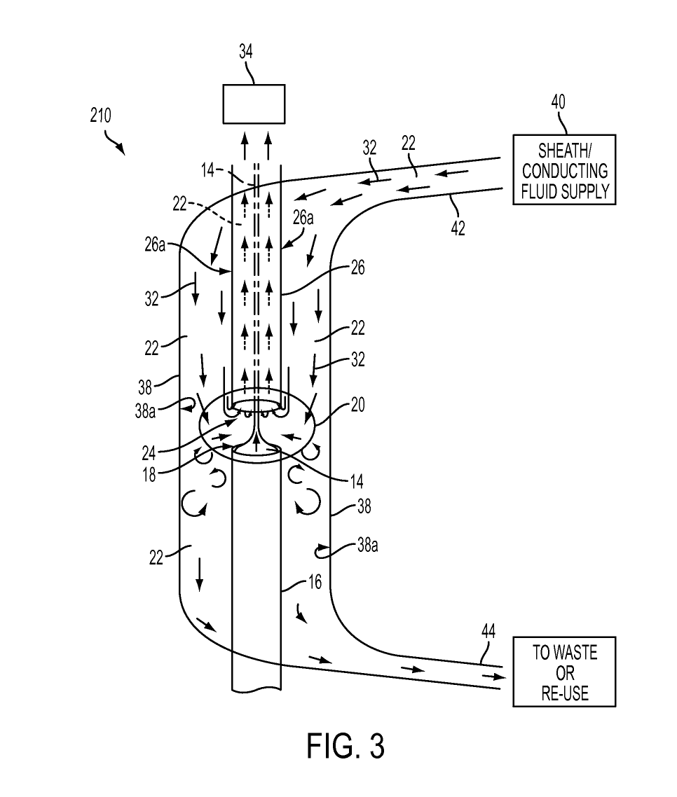

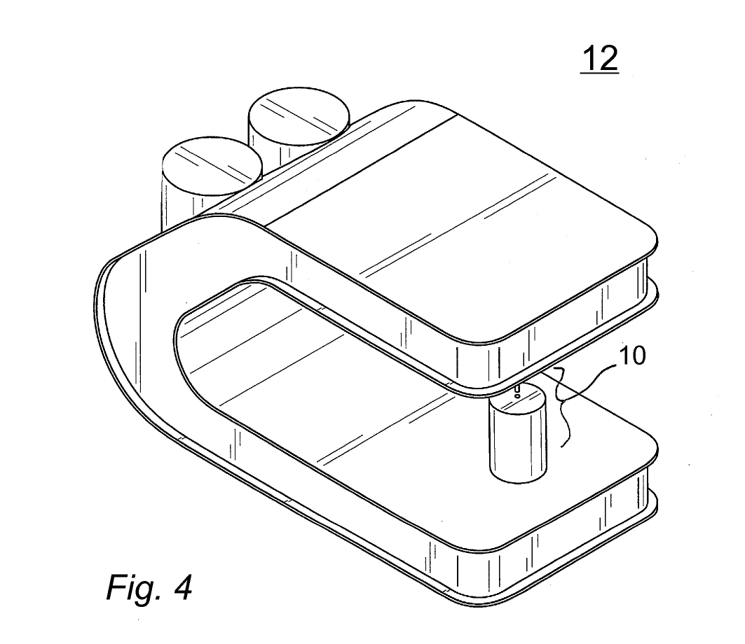

Optionally, and with reference to in FIG. 3 in which another flowcell 210 is shown, respective end portions of the sample injection probe 16 and combined fluid conduit 26 may be contained within a surrounding tubular wall 38 that defines an outer boundary of the conducting fluid flowpath 32, which has its inner boundary defined in part by the outer peripheral surface 26a of combined fluid conduit 26, and also defined in part by the outer peripheral surface of sample injection probe 16, as described above. Tubular wall 38 may have a circular or square cross section, for example, although other cross sectional shapes are envisioned. In the illustrated embodiment of FIG. 3, tubular wall 38 is in fluid communication with an upstream conducting fluid supply 40 via a conducting fluid inlet conduit 42, and is further in fluid communication with a downstream conducting fluid receptacle or conduit 44 that receives conducting fluid 22 that has not been drawn into combined fluid conduit 26. The fluid passing through downstream conducting fluid conduit 44 may be recirculated for re-use, or directed into a waste fluid receptacle or drain.

The dimensions of the tubular wall 38 and the combined fluid conduit 26 have been found to affect the performance of combined fluids flowing through combined fluid conduit 26 and into the downstream fluid analyzer 34. Decreasing the ratio of the inner diameter of tubular wall 38 to the outer diameter of combined fluid conduit 26 generally improves the uniformity (low turbulence) of flow, but can also increase the susceptibility to debris and bubbles entering the fluid stream. A desirable balance in performance has been identified when the ratio of the inner diameter of tubular wall 38 to the outer diameter of combined fluid conduit 26 ranges from about 3.5-to-1 to 5.0-to-1, for example, although it will be appreciated that dimensions at other ratios may be used without departing from the spirit and scope of the present invention. In one embodiment that has exhibited desirable performance characteristics, tubular wall 38 has an inner diameter of about 1.5 mm and combined fluid conduit 26 has an outer diameter of about 0.357 mm, yielding a ratio of about 4.2 to 1 and a radial spacing of about 0.5715 mm between tubular wall 38 and combined fluid conduit 26 when they are coaxially aligned.

The arrangement of FIG. 3 allows some of the conducting fluid 22 to bypass hydrodynamic focusing zone 20, or to enter and exit the focusing zone 20 without entering combined fluid conduit 26. The conducting fluid 22 that does not enter combined fluid conduit 26 may exhibit turbulent flow (illustrated with semi-circular arrows in FIG. 3) as it passes through and around focusing zone 20, in an area where contaminants such as air bubbles and particulates carried by conducting fluid 22 will tend to accumulate. The conducting fluid 22 that did not enter combined fluid conduit will continue away from focusing zone 20 and on toward the downstream conducting fluid conduit 44, from which it may continue to a waste drain or receptacle, or may be collected for re-use.

The flow paths illustrated and described with reference to FIG. 3 are achieved by ensuring that the lowest fluid pressure in the system is found at combined fluid inlet 24, so that during operation, fluids can only flow into combined fluid inlet 24. The highest fluid pressure in the system is found in sample injection probe 16, which ensures that during operation, sample fluid 14 will only flow out of sample fluid outlet 18 and into combined fluid inlet 24. The second-highest (also the third-lowest) fluid pressure in the system is found along conducting fluid inlet conduit 42, which ensures that at least some of the conducting fluid 22 will flow into combined fluid inlet 24 as it passes through hydrodynamic focusing zone 20, and further ensures that none of the conducting fluid 22 will enter sample fluid outlet 18.

The third-highest (also the second-lowest) fluid pressure in the system is found at downstream conducting fluid conduit 44, which ensures that (i) sample fluid 14 drawn out of sample fluid outlet 18 is drawn only into the lower-pressure zone of combined fluid inlet 24, and (ii) any conducting fluid 22 that does not enter combined fluid inlet 24 will tend to be carried away from hydrodynamic focusing zone 20 and into downstream conducting fluid conduit 44, since that conducting fluid will generally be carrying a higher concentration of undesirable bubbles or other contaminants (if present) that should preferably be removed from the system before they can enter combined fluid inlet 24. However, it is also envisioned that, if desired, the system could be operated without fluid flow through downstream conducting fluid conduit 44, so that conducting fluid 22 that does not enter combined fluid inlet 24 will still exhibit turbulence similar to that shown in FIG. 3, but the conducting fluid 22 may then stagnate, causing any concentration of bubbles or other contaminants to build in the area around sample injection probe 16, while some of the stagnated conducting fluid in this area may eventually be drawn into hydrodynamic focusing zone and combined fluid inlet 24.

The flowcell 210 of FIG. 3 also facilitates cleaning of the conducting fluid flowpath 32, including the outer peripheral surface 26a of combined fluid conduit 26 and an inner peripheral surface 38a of the tubular wall 38. This may be accomplished, for example, by flushing conducting fluid 22 or a cleaning fluid through conducting fluid inlet conduit 42, between tubular wall 38 and the combined fluid conduit 26 and sample inlet probe 16, and out through downstream conducting fluid conduit 44. Optionally, the rate and/or the direction of flow of cleaning fluid or conducting fluid may be changed or cycled in slow or rapid succession during a cleaning process, to help dislodge any debris or contaminants that may have collected on different surfaces, and to flush old sample and conducting fluids out of the flowcell.

In addition to flowcell 10, cytometer 12 generally includes an illumination source that directs focused light at an analyzer zone of the flowcell, and further includes fluid-handling equipment (pumps, valves, etc.), detection optics, and associated electronics, such as described in commonly-owned PCT Application No. PCT/US2013/072225, filed Nov. 27, 2013 and published Jun. 5, 2014 as International Publication No. WO 2014/085585, which is hereby incorporated herein by reference. An electronic control system is operable to control the flowcell and fluid-handling equipment, the illumination source, and the detection optics and electronics, in response to commands received by a separate computer (such as a lab workstation) that is run by an operator.

Thus, the present invention provides a cytometer flowcell in which a reversal or other significant change in the direction of flow for the conducting or sheath fluid, as it enters and exits the hydrodynamic focusing zone, reduces the likelihood of fluid turbulence and/or the inclusion of contaminants in the combined fluids as they enter the combined fluid conduit and pass into the fluid analyzer. This increases the reliability and accuracy of test results, reduces the likelihood of failed tests, reduces the level of precision required in aligning fluid conduits for a test, and therefore results in both improved tests and reduced time and costs for such tests.

Changes and modifications to the specifically described embodiments may be carried out without departing from the principles of the present invention, which is intended to be limited only by the scope of the appended claims, as interpreted according to the principles of patent law, including the doctrine of equivalents.

1. A cytometer flowcell comprising:
a combined fluid conduit having a combined fluid inlet, said combined fluid conduit defining an internal combined fluid flowpath in a downstream direction of said combined fluid inlet;
a conducting fluid flowpath defined outboard of said combined fluid conduit; and
a sample fluid injection probe having a sample fluid outlet spaced from said combined fluid inlet to form a hydrodynamic focusing zone therebetween;
wherein said combined fluid conduit and said conducting fluid flowpath outboard of said combined fluid conduit are arranged so that a flow of the conducting fluid is caused to change direction by at least about 90 degrees as the conducting fluid enters said hydrodynamic focusing zone and exits along the combined fluid flowpath.

2. The cytometer flowcell of claim 1, wherein said combined fluid conduit and said conducting fluid flowpath outboard of said combined fluid conduit are arranged so that the conducting fluid changes direction by about 180 degrees as the conducting fluid enters said hydrodynamic focusing zone and exits along the combined fluid flowpath.

3. The cytometer flowcell of claim 2, further comprising a conducting fluid outlet positioned in the downstream direction of said internal combined fluid flowpath.

4. The cytometer flowcell of claim 3, wherein said combined fluid conduit comprises an outer surface that defines an inner boundary of said conducting fluid flowpath.

5. The cytometer flowcell of claim 1, wherein said combined fluid conduit and said sample fluid injection probe are substantially parallel to one another.

6. The cytometer flowcell of claim 5, wherein said combined fluid conduit and said sample fluid injection probe are substantially coaxial.

7. The cytometer flowcell of claim 1, further comprising a generally tubular wall surrounding said combined fluid conduit and said sample fluid injection probe, and defining an outer boundary of said conducting fluid flowpath.

8. The cytometer flowcell of claim 7, wherein said generally tubular wall is in fluid communication with a conducting fluid inlet conduit and a conducting fluid outlet conduit, wherein said conducting fluid inlet conduit is configured to receive the conducting fluid from an upstream conducting fluid supply, and wherein said conducting fluid outlet conduit is operable to convey a portion of the conducting fluid that is not drawn into the combined fluid inlet.

9. The cytometer flowcell of claim 1, further in combination with a cytometer.

10. A cytometer flowcell comprising:
a combined fluid conduit having a combined fluid inlet and defining a combined fluid flowpath in a downstream direction of said combined fluid inlet, said combined fluid conduit configured to simultaneously convey a sample fluid and a conducting fluid together in the downstream direction away from said combined fluid inlet;
a sample fluid injection probe having a sample fluid outlet and defining a sample fluid flowpath upstream of said sample fluid outlet, wherein said sample fluid outlet is spaced from said combined fluid inlet to thereby form a conducting fluid inlet gap between said sample fluid outlet and said combined fluid inlet;
a conducting fluid source positioned in the downstream direction of the combined fluid flowpath, relative to said combined fluid inlet;
a conducting fluid flowpath defined outboard of said combined fluid conduit, wherein a flow of the conducting fluid between said conducting fluid source and said conducting fluid inlet gap, outboard of said combined fluid conduit, is generally in a direction opposite that of the downstream direction of the combined fluid flowpath; and
wherein said conducting fluid source, said conducting fluid flowpath, and said combined fluid conduit are arranged so that a flowpath of the conducting fluid changes direction by at least about 90 degrees as the conducting fluid enters said conducting fluid inlet gap and continues in the downstream direction away from the combined fluid inlet.

11. The cytometer flowcell of claim 10, wherein said conducting fluid source, said conducting fluid flowpath, and said combined fluid conduit are arranged so that the conducting fluid changes direction by about 180 degrees as the conducting fluid enters said conducting fluid inlet gap and continues in the downstream direction away from the combined fluid inlet.

12. The cytometer flowcell of claim 10, wherein said combined fluid conduit and said sample fluid injection probe are substantially parallel to one another.

13. The cytometer flowcell of claim 12, wherein said combined fluid conduit and said sample fluid injection probe are substantially coaxial.

14. The cytometer flowcell of claim 10, further comprising a generally tubular wall surrounding said combined fluid conduit and said sample fluid injection probe, and defining an outer boundary of said conducting fluid flowpath.

15. The cytometer flowcell of claim 14, wherein said generally tubular wall is in fluid communication with a conducting fluid inlet conduit and a conducting fluid outlet conduit, wherein said conducting fluid inlet conduit is configured to receive the conducting fluid from an upstream conducting fluid supply, and wherein said conducting fluid outlet conduit is operable to convey a portion of the conducting fluid that is not drawn into the combined fluid inlet.

16. The cytometer flowcell of claim 10, further in combination with a cytometer.

17. A method of directing fluids through a cytometer flowcell, said method comprising:
positioning a combined fluid conduit in the cytometer flowcell, the combined fluid conduit having a combined fluid inlet, and the combined fluid conduit defining an internal combined fluid flowpath in a downstream direction of the combined fluid inlet;
positioning a sample fluid injection probe in the cytometer flowcell, the sample fluid injection probe having a sample fluid outlet;
positioning the sample fluid outlet of the sample fluid injection probe in spaced arrangement from the combined fluid inlet to form a hydrodynamic focusing zone therebetween;
positioning a conducting fluid outlet outside of the combined fluid conduit and in the downstream direction of the combined fluid inlet; and
directing a flow of the conducting fluid out of the conducting fluid outlet, into the hydrodynamic focusing zone, and along the combined fluid flowpath, whereby the conducting fluid is caused to change direction by at least about 90 degrees.

18. The method of claim 17, wherein said directing the flow of the conducting fluid comprises changing the conducting fluid changes direction by about 180 degrees as the conducting fluid enters said hydrodynamic focusing zone and exits along the combined fluid flowpath.

19. The method of claim 18, wherein said positioning the combined fluid conduit in the cytometer flowcell comprises positioning the combined fluid conduit within in a generally tubular wall, and said sample fluid injection probe in the cytometer flowcell comprises positioning the sample fluid injection probe within the generally tubular wall, wherein the generally tubular wall defines an outer boundary of the conducting fluid flowpath.

20. The method of claim 19, wherein said directing the flow of the conducting fluid comprises directing the conducting fluid between the generally tubular wall and an outer surface of the combined fluid conduit in an upstream direction prior to directing the conducting fluid into the hydrodynamic focusing zone, and wherein said directing the flow of the conducting fluid further comprises directing a portion of the conducting fluid past the hydrodynamic focusing zone and into a conducting fluid outlet conduit that is in fluid communication with the generally tubular wall.
